(19) United States
(12) Patent Application Publication
(10) Pub. No.: US 2015/0213042 A1
(43) Pub. Date: Jul. 30, 2015

(54) SEARCH TERM OBTAINING METHOD AND SERVER, AND SEARCH TERM RECOMMENDATION SYSTEM

(71) Applicant: TENCENT TECHNOLOGY (SHENZHEN) COMPANY LIMITED, Shenzhen (CN)

(72) Inventors: YUANCHENG CAO, Shenzhen (CN); YUE CAO, Shenzhen (CN); HUABIN YIN, Shenzhen (CN); HEJUN NING, Shenzhen (CN); JIANTAO GONG, Shenzhen (CN)

(73) Assignee: TENCENT TECHNOLOGY (SHENZHEN) COMPANY LIMITED

(21) Appl. No.: 14/678,355

(22) Filed: Apr. 3, 2015

Related U.S. Application Data
(63) Continuation of application No. PCT/CN2013/079173, filed on Jul. 11, 2013.

(30) Foreign Application Priority Data
Oct. 9, 2012 (CN) 2012-10379599.5

(51) Int. Cl. G06F 17/30

(52) U.S. Cl. CPC G06F 17/3097; G06F 17/30705

(57) ABSTRACT

The present disclosure provides a method, server, system, and a storage medium for search term obtaining and recommendation. A tag library is set to include multiple tags, multiple categories, and multiple application keywords stored therein. When it is determined that a received application keyword is a fuzzy keyword, a tag matching the received application keyword is obtained according to the received application keyword. A category corresponding to the matching tag is obtained. Categories are obtained and gathered to find a category from the obtained categories that appears most frequently. A tag corresponding to the category that appears most frequently is found as a recommended search term. As such, when a user has an unclear subjective search purpose, a potential requirement of the user can be excavated, or a user's requirements can be refined, to allow a search result better matching user's intentions to thus improve practicability.

### RELATED APPLICATION

This application is a continuation of PCT Application No. PCT/CN2013/079173, filed on Jul. 11, 2013, which claims priority to Chinese Patent Application No. 201210379599.5, filed with the Chinese Patent Office on Oct. 9, 2012 by the applicant Tencent Technology (Shenzhen) Company Limited and entitled “SEARCH TERM OBTAINING METHOD, SERVER, AND SEARCH TERM RECOMMENDATION METHOD AND SYSTEM”, all of which are incorporated herein by reference in their entirety.

### FIELD OF THE TECHNOLOGY

The present disclosure relates to Internet and computer technologies, and in particular, relates to methods, servers, systems, and storage media for obtaining and/or recommending search terms.

### BACKGROUND OF THE DISCLOSURE

With the rapid development of the Web 2.0 technology, Internet data massively increases. How to provide accurate and useful information for an Internet user is particularly important. A search policy of a general search engine is to obtain data as much as possible, which, however, has a low data processing level, for example, search engines such as Baidu and Google generally list a large number of search results according to similarity of an input keyword. A prominent problem of the general search engine is: in the search results, there is excessively much valueless information, useful information is insufficient and unstructured, and there is no personalized mechanism for returning the search results.

Valueless data occupies a high proportion in the search results that are provided by the general search engine, and the data valueless to the user wastes considerable storage and operation capabilities of a data center, which means that not only a large proportion of energy consumed by a single search is wasted, but also extraction of useful information is interfered with, so that the user may need to search for multiple times.

A vertical search engine is a new search engine service mode used to solve technical problems of the general search engine including large amount information, inaccurate query results, and insufficient search depth. This mode provides information of certain value and relevant services to a specific field, a specific group of people, or a specific requirement, and is characterized by “specialized, accurate, and deep” for certain industries. Compared with disorderliness of massive information of the general search engine, the vertical search engine appears to be more focused, more specific, and deeper. However, due to industry characteristics that the vertical search engine has, the data amount of the vertical search engine is limited, and when the user needs to search in different fields, the user has to use different vertical search engines, which makes an operation inconvenient.

In addition, when searching, differences may exist subjectively between different users. A failure to obtain an expected search result is often caused due to the fact that an accurate keyword cannot be provided. Therefore, in the existing technology, neither the general search engine nor the vertical search engine has a function of recommending a search term to a user according to a fuzzy keyword provided by the user and then recommending a search result. Existing methods cannot meet a potential search requirement of the user, and have a certain limitation.

Therefore, there is a need to solve technical problems in the Internet and computer technology to provide a practical function for recommending a search term to a user according to a fuzzy keyword provided by the user and then recommending a search result.

### SUMMARY

Embodiments of the present invention provide a search term obtaining method, a server, a search term recommendation method and system, and a storage medium, to solve technical problems existing in a general search engine with low data processing capability, or in a vertical search engine with inconvenient operation, or in an existing search engine that cannot intelligently recommend a search term and furthermore recommend a search result to a user.

The present disclosure provides a search term obtaining method, implemented at a server end, including: setting a tag library including multiple tags, multiple categories, and multiple application keywords stored in the tag library; determining whether a received application keyword is a fuzzy keyword; obtaining a tag matching the received application keyword according to the received application keyword if the received application keyword is a fuzzy keyword; obtaining a category corresponding to the matching tag according to the matching tag; gathering obtained categories to determine a category thereof that appears most frequently; and determining a tag corresponding to the category that appears most frequently as a recommended search term.

The present disclosure further provides a server, including: a tag library, a matching unit, a gathering unit, and a recommended term outputting unit. The tag library includes multiple tags, multiple categories, and multiple application keywords stored in the tag library. The matching unit is configured to determine, after receiving an application keyword, whether the received application keyword is a fuzzy keyword, and to obtain a tag matching the received application keyword according to the received application keyword if the received application keyword is a fuzzy keyword. The gathering unit is configured to obtain a category corresponding to the matching tag according to the matching tag obtained by the matching unit, and to gather obtained categories to find a category thereof that appears most frequently. The recommended term outputting unit is configured to determine a tag corresponding to the category that appears most frequently as a recommended search term.

The present disclosure further provides a search term recommendation system, including a server and at least one user end. The server is configured to receive an application keyword from the user end, and to send a recommended search term to the user end for the user end to display the recommended search term to a user. The server further includes a tag library, a matching unit, a gathering unit, and a recommended term outputting unit.

The tag library includes multiple tags, multiple categories, and multiple application keywords stored in the tag library. The matching unit is configured to receive the application keyword sent by the user end, to determine whether the received application keyword is a fuzzy keyword, and to obtain a tag matching the received application keyword according to the received application keyword if the received application keyword is a fuzzy keyword. The gathering unit is configured to obtain a category corresponding to the matching tag according to the matching tag obtained by the matching unit, and to gather obtained categories to find a category thereof that appears most frequently. The recommended term outputting unit is configured to determine a tag corresponding to the category that appears most frequently as a recommended search term.

Compared with the existing technology, in the embodiments of the present invention, popular recommended terms with a same functional characteristic can be found by using an application keyword that is input directly by a user or exported from a search result of a general search engine, and are displayed to the user, so that in a case in which a subjective search purpose of the user is unclear, a potential requirement of the user can be excavated, or a user's requirement can be refined, to allow a search result better matching user's intention. Therefore, the present disclosure has very strong practicability.

Other aspects or embodiments of the present disclosure can be understood by those skilled in the art in light of the description, the claims, and the drawings of the present disclosure.

### BRIEF DESCRIPTION OF THE DRAWINGS

The foregoing description is only a summary of technical solutions of the present disclosure. To help understand technical means of the present disclosure more clearly to implement the technical means according to content of the specification, and to make the foregoing features and advantages of the present disclosure more comprehensive, detailed description are provided below with reference to accompanying drawings by using preferred embodiments, where:

FIG. 1 is a flowchart of a search term obtaining method according to an exemplary embodiment of the present invention;

FIG. 2 is a schematic diagram of a search process according to an exemplary embodiment of the present invention;

FIG. 3 is a flowchart of another search term obtaining method according to an exemplary embodiment of the present invention;

FIG. 4 is a flowchart of a search term recommendation method according to an exemplary embodiment of the present invention;

FIG. 5 is a flowchart of another search term recommendation method according to an exemplary embodiment of the present invention;

FIG. 6 is a structural diagram of a server according to an exemplary embodiment of the present invention;

FIG. 7 is a structural diagram of another server according to an exemplary embodiment of the present invention;

FIG. 8 is a structural diagram of a search term recommendation system according to an exemplary embodiment of the present invention;

FIG. 9 is a diagram of correspondences between a category, a tag, and an application keyword according to an exemplary embodiment of the present invention; and

FIG. 10 illustrates an exemplary computing device consistent with various disclosed embodiments.

### DETAILED DESCRIPTION OF EMBODIMENTS

To further describe the technical means used by the present disclosure and the technical effects of the present disclosure, the following describes in detail, with reference to the accompanying drawings by using preferred embodiments, specific implementation manners, methods, steps, and technical effects of a search term obtaining method, a server, and a search term recommendation method and system that are provided by the present disclosure, and describes a corresponding storage medium.

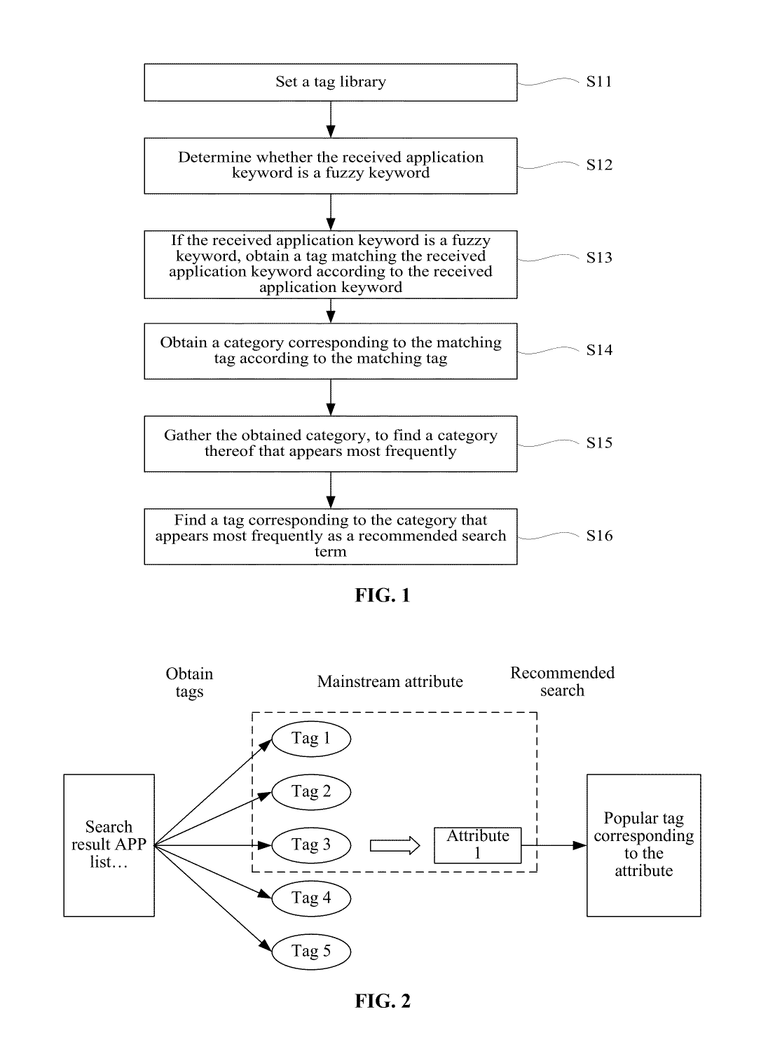

In the present invention, an implicit requirement of a user can be found according to an input keyword, and a recommended search term can be output. Referring to FIG. 1, FIG. 1 is a flowchart of a search term obtaining method according to an exemplary embodiment of the present invention. The method is implemented at a server end, and includes the following steps S11 to S16.

S11: includes setting a tag library. Multiple tags, multiple categories, and multiple application keywords are stored in the tag library. Each category includes multiple tags, each application keyword corresponds to at least one tag, and each tag belongs to at least one category.

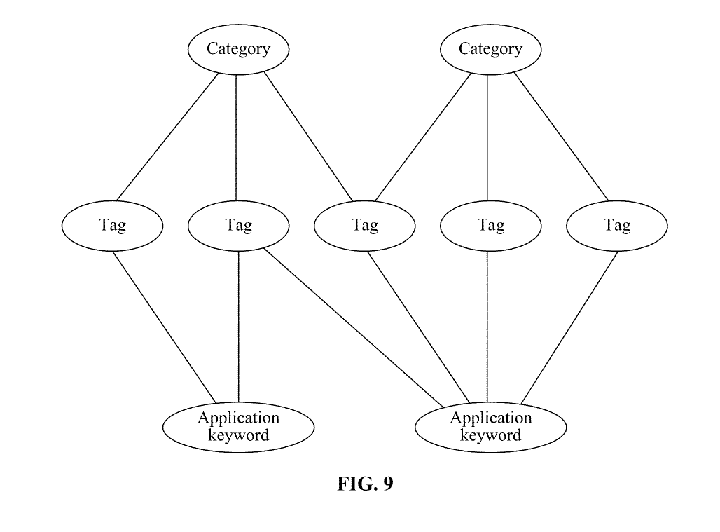

Referring to FIG. 9, an application keyword refers to content that a user intends to search for, and the tag library configures a corresponding tag for an application keyword that may be input, where the tag needs to cover various characteristics of the application keyword. For example, if the application keyword is “angry birds”, corresponding tags “cartoon”, “brain development”, and “throwing” may be configured for the application keyword is “angry birds”. For another example, if the application keyword is “WeChat”, corresponding tags “intercom”, “chat”, “voice”, “file transmission”, and “memorandum making” may be configured for the application keyword is “WeChat”. A correspondence between an application keyword and a tag is configured according to a mechanism of data mining and manual check.

In addition, each tag corresponds to at least one category, and correspondences between categories and tags are categorized according to functional characteristics of the tags. For example, tags “alarm clock”, “Trojan horse killing”, and “novel reading” correspond to one category “functional tag”. For another example, tags “3D”, “horizontal screen”, and “vertical screen” correspond to one category “interface”, and tags “gravity sensing” and “Bluetooth networking” correspond to one category “characteristic”.

S12: includes determining whether the received application keyword is a fuzzy keyword.

In this embodiment, the application keyword may be input directly by the user, and may also be an output result from a general search engine or from a vertical search engine. For example, the user may directly type “angry birds” as the application keyword; and the user may also input “angry birds” into the general search engine, and the general search engine obtains one search result list (which is generally referred to as an APP characteristic list), where the search result list may include “angry birds back to school, angry birds space, and angry birds high definition . . . ”, and then exports each result in the search result list as the application keyword.

Herein, the fuzzy keyword refers to a word that does not indicate a clear subjective intention of the user, and a correlation score may be configured for the application keyword to determine whether the application keyword is a fuzzy keyword. For example, when the user inputs “QQ2012”, the user intends to search for a piece of specific software, a search purpose of the user is clear, and the search may be directly performed with the application keyword “QQ2012” as the search term by using the general search engine, without a need to display a recommended term to the user; and therefore, a high score may be set for “QQ2012”. However, if the user inputs “Tencent” to perform a search, but the user may intend to search for a type of software of the Tencent company, at this time, the search purpose is fuzzy; and therefore, a low score may be set for “Tencent”, and the next step is performed.

For determining whether the correlation score is high or low, a correlation score threshold may be preset in the tag library. When the correlation score of the application keyword is lower than the threshold, it is determined that the application keyword is a fuzzy keyword; otherwise, it is determined that the application keyword is not a fuzzy keyword. Certainly, whether the application keyword is a fuzzy keyword may also be determined by using another preset standard. The determining manner also similarly applies to the following embodiment as disclosed herein.

In the tag library, a corresponding correlation score may be stored for each stored application keyword; and after an application keyword is received, a stored application keyword consistent with the received application keyword is found in the tag library, and a correlation score corresponding to the stored application keyword is obtained as a correlation score of the received application keyword, to determine whether the received application keyword is a fuzzy keyword.

S13: includes, if the received application keyword is a fuzzy keyword, obtaining a tag matching the received application keyword according to the received application keyword; otherwise, directly using the received application keyword as a search term.

After the application keyword is received, tag matching is performed for the application keyword according to the tag library, and the tag matching the received application keyword is obtained from the tag library. Specifically, a stored application keyword consistent with the received application keyword is found in the tag library, and a tag matching the stored application keyword is obtained as a tag matching the received application keyword. For example, three matching tags “cartoon”, “brain development”, and “throwing” are obtained according to the application keyword “angry birds”.

S14: includes obtaining a category corresponding to the matching tag according to the matching tag.

Each tag corresponds to a category, and correspondences between categories and tags are categorized according to functional characteristics of the tags. In this step, one or more categories may be obtained (if a search result of a search engine is used as an application keyword, a large number of categories may be obtained).

S15: includes gathering obtained categories, to find a category thereof that appears most frequently.

In this step, the categories obtained in the previous step is gathered, to find the category thereof that appears most frequently, where the category that appears most frequently is a category having the largest correlation to the content searched for by the user. Corresponding results of the tag and the category that are obtained in step S14 and step S15 may be referred to as attribute distribution of the tag.

S16: includes finding a tag corresponding to the category that appears most frequently as a recommended search term; and preferably finding, from the tag library, a popular tag corresponding to the category that appears most frequently as the recommended search term.

The category that appears most frequently is a category having the largest correlation to the content searched for by the user. The category may include multiple tags, and popularity of each tag thereof may be set manually or determined according to a record of the number of times that the tag is searched for. For example, a category “interface” includes three tags “3D”, “horizontal screen”, and “vertical screen”, where the tag “3D” is set to be the most popular tag because it is frequently searched for, that is, if the category “interface” is the category that appears most frequently, in this step, the tag “3D” is output as a recommended search term. Certainly, there may be multiple search terms that are finally output, which may be implemented by setting a popularity threshold for the tag.

For easy understanding, the following describes an entire search process by using a specific embodiment. Referring to FIG. 2, it is assumed that one application keyword “WeChat” is output from a search result of a search engine, and then five tags are found according to “WeChat” by using the tag library: a tag 1 is “intercom”, a tag 2 is “chat”, a tag 3 is “voice”, a tag 4 is “file transmission”, and a tag 5 is “memorandum making”. Then, attribute categories are gathered for the five tags, to obtain that the tag 1, the tag 2, and the tag 3 belong to one category: an attribute 1, that is, “Tencent”. It can be seen that, in the five tags, the category “Tencent” appears for three times, and is the category that appears most frequently.

Next, the category “Tencent” is scanned, to obtain a most popular tag “QQ”, and finally the tag “QQ” is output as a recommended term to a user. By analogy, retrieval and recommendation are performed for each application keyword output from the search result of the search engine, and a recommended term that is potentially relevant to content searched for by the user is displayed to the user. Therefore, by using the present disclosure, a potential requirement of the user can be excavated, or a requirement of the user can be refined, allowing a search result to better match user's intention.

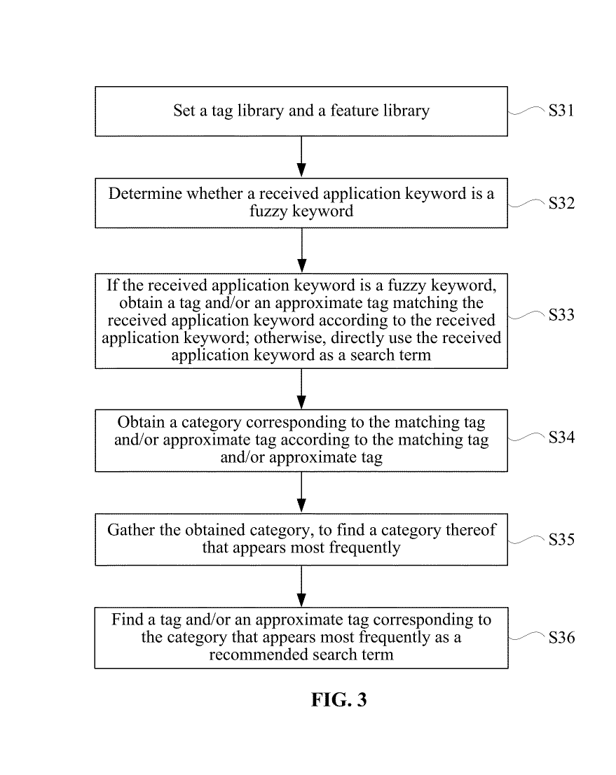

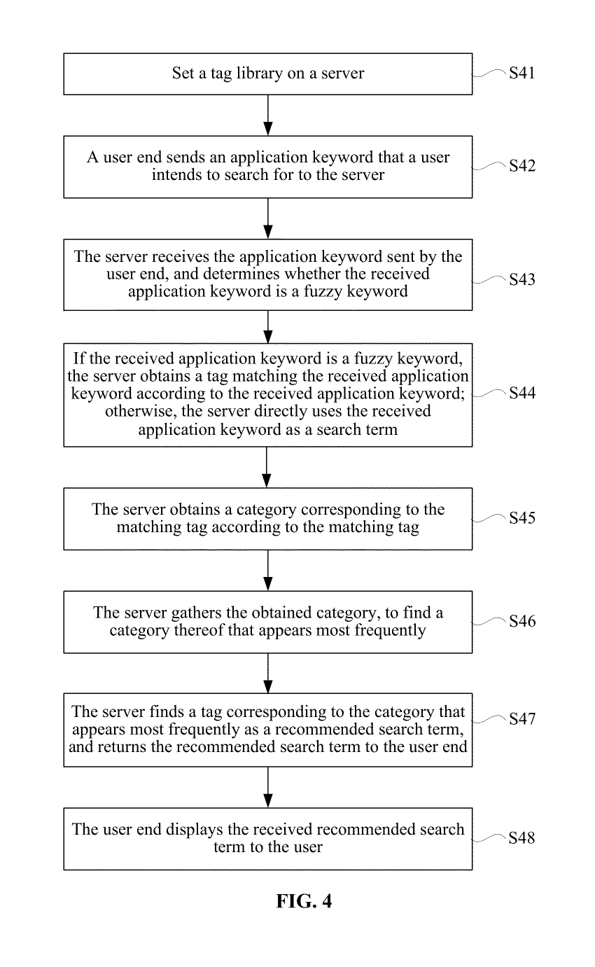

Referring to FIG. 3, FIG. 3 is a flowchart of another search term obtaining method according to an exemplary embodiment of the present invention. The method includes the following steps S31 to S36.

S31: includes setting a tag library and a feature library.

Multiple tags, multiple categories, and multiple application keywords are stored in the tag library, where each category includes multiple tags, each application keyword corresponds to at least one tag, and each tag belongs to at least one category.

Multiple approximate tags are stored in the feature library, and the approximate tags correspond to the tags in the tag library. A functional characteristic of each approximate tag is similar to a functional characteristic of one or more corresponding tags, that is, the approximate tag and a corresponding tag that comes from the tag library belong to a same category. Existence of the feature library facilitates system extension and improvement.

S32: includes determining whether a received application keyword is a fuzzy keyword.

Herein, the fuzzy keyword refers to a word that does not indicate a clear subjective intention of a user, and a correlation score may be configured for the application keyword to determine whether the application keyword is a fuzzy keyword. For example, when the user inputs “QQ2012”, the user intends to search for a piece of specific software, a search purpose of the user is clear, and the search may be directly performed with the application keyword “QQ2012” as the search term by using a general search engine, without a need to display a recommended term to the user; and therefore, a high score may be set for “QQ2012”. However, if the user inputs “Tencent” to perform a search, but the user may intend to search for a type of software of the Tencent company, at this time, the search purpose is fuzzy; and therefore, a low score may be set for “Tencent”, and the next step is performed.

S33: includes, if the received application keyword is a fuzzy keyword, obtaining a tag and/or an approximate tag, matching the received application keyword according to the received application keyword; otherwise, directly using the received application keyword as a search term.

S34: includes obtaining a category corresponding to the matching tag and/or matching approximate tag, according to the matching tag and/or matching approximate tag.

In an application keyword matching process, an approximate tag in the feature library may match the application keyword, and because the approximate tag and the corresponding tag that comes from the tag library belong to a same category, similarly a corresponding category can also be obtained.

S35: includes gathering the obtained categories, to find a category thereof that appears most frequently.

In the previous step, multiple categories may be obtained (if a search result of a search engine is used as an application keyword, a large number of categories may be obtained). In this step, these categories are gathered, to find the category that appears most frequently, where the category that appears most frequently is a category having the largest correlation to the content searched for by the user.

S36: includes finding a tag and/or an approximate tag corresponding to the category that appears most frequently as a recommended search term; and preferably finding, from the tag library, a popular tag and/or popular approximate tag corresponding to the category that appears most frequently as the recommended retrieval term.

The category that appears most frequently is a category having the largest correlation to the content searched for by the user, where this category may include multiple tags, and the popular tag may be displayed as the recommended search term to the user.

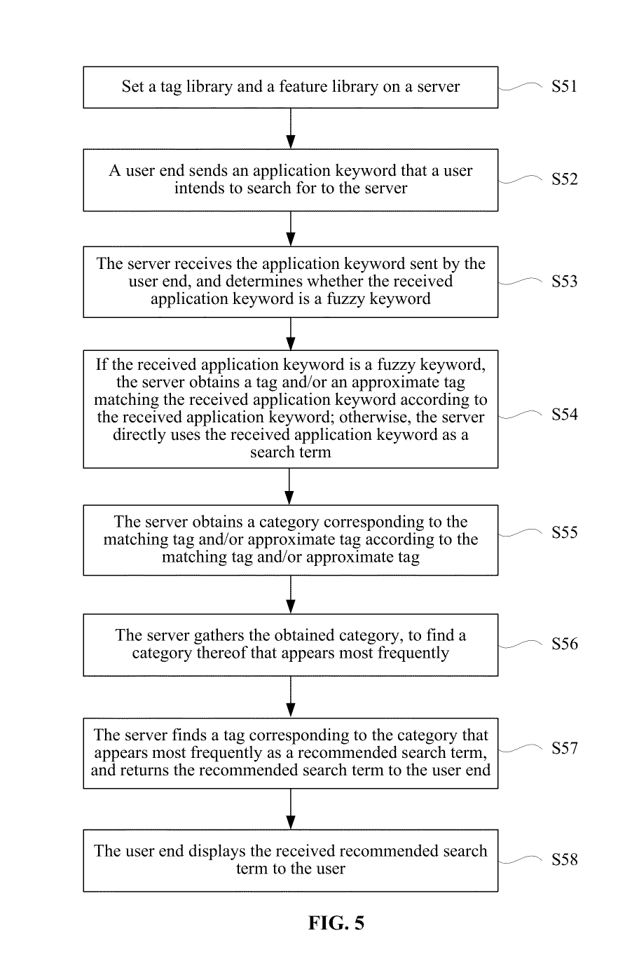

The present disclosure further provides a search term recommendation method, to recommend a search term that meets a retrieval intention of a user at a user end by using a server, so as to fully meet a search requirement of the user. Referring to FIG. 4, FIG. 4 is a flowchart of a search term recommendation method according to an exemplary embodiment of the present invention. The method includes the following steps S41 to S48.

S41: includes setting a tag library on a server. Multiple tags, multiple categories, and multiple application keywords are stored in the tag library, where each category includes multiple tags, each application keyword corresponds to at least one tag, and each tag belongs to at least one category. Each tag corresponds to at least one category, and correspondences between categories and tags are categorized according to functional characteristics of the tags.

S42: a user end sends an application keyword that a user intends to search for to the server.

The application keyword refers to content that the user intends to search for, and the tag library configures a corresponding tag for each application keyword that may be input, where the tag needs to cover various characteristics of the application keyword.

S43: the server receives the application keyword sent by the user end, and determines whether the received application keyword is a fuzzy keyword.

Herein, the fuzzy keyword refers to a word that does not indicate a clear subjective intention of the user. As described above, a correlation score may be configured for the application keyword to determine whether the application keyword is a fuzzy keyword.

S44: if the received application keyword is a fuzzy keyword, the server obtains a tag matching the received application keyword according to the received application keyword; otherwise, the server directly uses the received application keyword as a search term.

After receiving the application keyword, the server performs tag matching for the application keyword according to the tag library, and obtains the tag matching the received application keyword from the tag library, that is, finds, in the tag library, a stored application keyword consistent with the received application keyword, and obtains a tag matching the stored application keyword as a tag matching the received application keyword.

S45: the server obtains a category corresponding to the matching tag according to the matching tag.

Each tag corresponds to a category, and correspondences between categories and tags are categorized according to functional characteristics of the tags.

S46: the server gathers the obtained categories, to find a category thereof that appears most frequently.

In the previous step, multiple categories may be obtained. In this step, these categories are gathered, to find the category that appears most frequently, where the category that appears most frequently is a category having the largest correlation to the content searched for by the user.

S47: the server finds a tag corresponding to the category that appears most frequently as a recommended search term, and returns the recommended search term to the user end. Preferably, the server finds a popular tag corresponding to the category that appears most frequently as a recommended search term, and returns the recommended search term to the user end.

The category that appears most frequently is a category having the largest correlation to the content searched for by the user. The category may include multiple tags, and popularity of each tag thereof may be set manually or determined according to a record of the number of times that the tag is searched for.

S48: the user end displays the received recommended search term to the user.

Referring to FIG. 5, FIG. 5 is a flowchart of another search term recommendation method according to an exemplary embodiment of the present invention. The method includes steps S51 to S58.

S51: includes setting a tag library and a feature library on a server.

Multiple tags, multiple categories, and multiple application keywords are stored in the tag library, where each category includes multiple tags, each application keyword corresponds to at least one tag, and each tag belongs to at least one category. Each tag corresponds to at least one category, and correspondences between categories and tags are categorized according to functional characteristics of the tags.

Multiple approximate tags are stored in the feature library, and the approximate tags correspond to the tags in the tag library. A functional characteristic of each approximate tag is similar to a functional characteristic of one or more corresponding tags, that is, the approximate tag and a corresponding tag that comes from the tag library belong to a same category. Existence of the feature library facilitates system extension and improvement.

S52: a user end sends an application keyword that a user intends to search for to the server.

The application keyword refers to content that the user intends to search for, and the tag library configures a corresponding tag for each application keyword that may be input, where the tag needs to cover various characteristics of the application keyword.

S53: the server receives the application keyword sent by the user end, and determines whether the received application keyword is a fuzzy keyword.

Herein, the fuzzy keyword refers to a word that does not indicate a clear subjective intention of the user. As described above, a correlation score may be configured for the application keyword to determine whether the application keyword is a fuzzy keyword.

S54: if the received application keyword is a fuzzy keyword, the server obtains a tag and/or an approximate tag matching the received application keyword according to the received application keyword; otherwise, the server directly uses the received application keyword as a search term.

S55: the server obtains a category corresponding to the matching tag and/or matching approximate tag according to the matching tag and/or matching approximate tag.

In an application keyword matching process, an approximate tag in the feature library may match the application keyword, and because the approximate tag and the corresponding tag that comes from the tag library belong to a same category, similarly a corresponding category can also be obtained.

S56: the server gathers the obtained categories, to find a category thereof that appears most frequently.

In the previous step, multiple categories may be obtained. In this step, these categories are gathered, to find the category that appears most frequently, where the category that appears most frequently is a category having the largest correlation to the content searched for by the user.

S57: the server finds a tag corresponding to the category that appears most frequently as a recommended search term, and returns the recommended search term to the user end. Preferably, the server finds a popular tag corresponding to the category that appears most frequently as a recommended search term, and returns the recommended search term to the user end.

The category that appears most frequently is a category having the largest correlation to the content searched for by the user. The category may include multiple tags, and popularity of each tag thereof may be set manually or determined according to a record of the number of times that the tag is searched for.

S58: the user end displays the received recommended search term to the user.

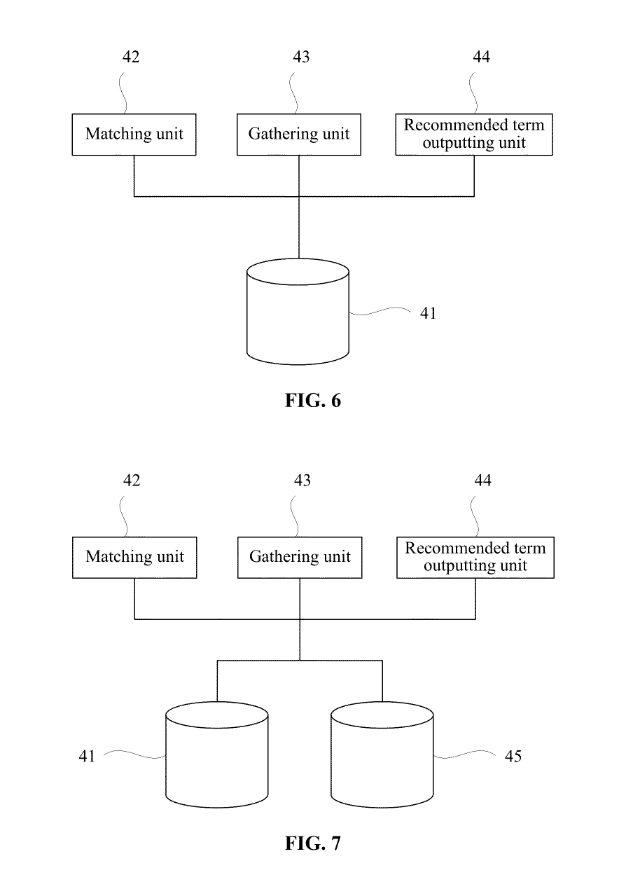

The present disclosure further provides a server. Referring to FIG. 6, FIG. 6 is a structural diagram of a server according to an embodiment of the present invention. The server includes a tag library 41, a matching unit 42, a gathering unit 43, and a recommended term outputting unit 44.

The tag library 41 is respectively connected to the matching unit 42, the gathering unit 43, and the recommended term outputting unit 44, the gathering unit 43 is connected to the matching unit 42, and the recommended term outputting unit 44 is connected to the gathering unit 43. Multiple tags, multiple categories, and multiple application keywords are stored in the tag library 41, where each category includes multiple tags, each application keyword corresponds to at least one tag, and each tag belongs to at least one category.

Referring to FIG. 9, an application keyword refers to content that a user intends to search for, and the tag library 41 configures a corresponding tag for each application keyword that may be input, where the tag needs to cover various characteristics of the application keyword. Correspondences between categories and tags are categorized according to functional characteristics of the tags. A correspondence between an application keyword and a tag may be configured according to a mechanism of data mining and manual check. For example, for an application keyword “angry birds”, corresponding tags “cartoon”, “brain development”, and “throwing” may be configured for the application keyword is “angry birds”. For another example, for an application keyword “WeChat”, corresponding tags “intercom”, “chat”, “voice”, “file transmission”, and “memorandum making” may be configured for the application keyword is “WeChat”. The correspondence between an application keyword and a tag is configured according to a mechanism of data mining and manual check. Each tag corresponds to at least one category, and correspondences between categories and tags are categorized according to functional characteristics of the tags. For example, tags “alarm clock”, “Trojan horse killing”, and “novel reading” correspond to one category “functional tag”. For another example, tags “3D”, “horizontal screen”, and “vertical screen” correspond to one category “interface”.

The server in this embodiment may be separately used, to receive an application keyword input by a user; and may also be used together with a general search engine, where a search result output by the general search engine may be used as an application keyword input into the server.

In operation, when receiving an application keyword, the matching unit 42 obtains, for the application keyword by using the tag library 41, a tag matching the application keyword. Each tag corresponds to a category, and the gathering unit 43 finds, by using the tag library 41, a category corresponding to each tag output by the matching unit 42, and gathers the found category, to find a category thereof that appears most frequently. Finally, the gathering unit 43 outputs the category that appears most frequently to the recommended term outputting unit 44, and the recommended term outputting unit 44 scans the tag library 41, to find a tag corresponding to the category as a recommended search term, and preferably find a popular tag corresponding to the category as the recommended search term.

The category that appears most frequently is a category having the largest correlation to the content searched for by the user. The category may include multiple tags, and popularity of a tag thereof may be set manually or determined according to a record of the number of times that the tag is searched for. For example, a category “interface” includes three tags “3D”, “horizontal screen”, and “vertical screen”, where the tag “3D” is set to be the most popular tag because it is frequently searched for, that is, if the category “interface” is the category that appears most frequently, the recommended term outputting unit 44 outputs the tag “3D” as a recommended search term. Certainly, there may be multiple search terms that are finally output, which may be implemented by setting a popularity threshold for the tag.

Especially, when receiving the application keyword, the matching unit 42 may first determine whether the received application keyword is a fuzzy keyword, directly perform retrieval by using the application keyword as a retrieval word if the received application keyword is not a fuzzy keyword, and obtain a tag matching the received application keyword according to the received application keyword if the received application keyword is a fuzzy keyword. Herein, the fuzzy keyword refers to a word that does not indicate a clear subjective intention of the user, and a correlation score may be configured for the application keyword to determine whether the application keyword is a fuzzy keyword.

For example, when the user inputs “QQ2012”, at this time the user intends to search for a piece of specific software, a search purpose of the user is clear, and the search may be directly performed with the application keyword “QQ2012” as the search term by using the general search engine, without a need to display a recommended term to the user; and therefore, a high score may be set for “QQ2012”. However, if the user inputs “Tencent” to perform a search, but the user may intend to search for a type of software of the Tencent company, at this time, the search purpose is fuzzy; and therefore, a low score may be set for “Tencent”, and the search is continued.

Referring to FIG. 7, FIG. 7 is a structural diagram of another server according to an embodiment of the present invention. The server includes a tag library 41, a matching unit 42, a gathering unit 43, a recommended term outputting unit 44, and a feature library 45.

The tag library 41 is connected to the feature library 45, the tag library 41 and the feature library 45 are both respectively connected to the matching unit 42, the gathering unit 43, and the recommended term outputting unit 44, the gathering unit 43 is connected to the matching unit 42, and the recommended term outputting unit 44 is connected to the gathering unit 43.

Different from that in the embodiment in FIG. 4, the server in this embodiment further includes the feature library 45. Multiple approximate tags are stored in the feature library 45, and the approximate tags correspond to the tags in the tag library 41. A functional characteristic of each approximate tag is similar to a functional characteristic of one or more corresponding tags, that is, the approximate tag and a corresponding tag that comes from the tag library belong to a same category. After receiving an application keyword, the matching unit 42 may obtain a tag matching the received application keyword from the tag library 41 and/or obtain an approximate tag matching the received application keyword from the feature library 45, and then obtain a category corresponding to the tag and/or approximate tag. It can be seen that, a search function of a system can be improved by adding an approximate tag to the feature library 45, which facilitates system extension.

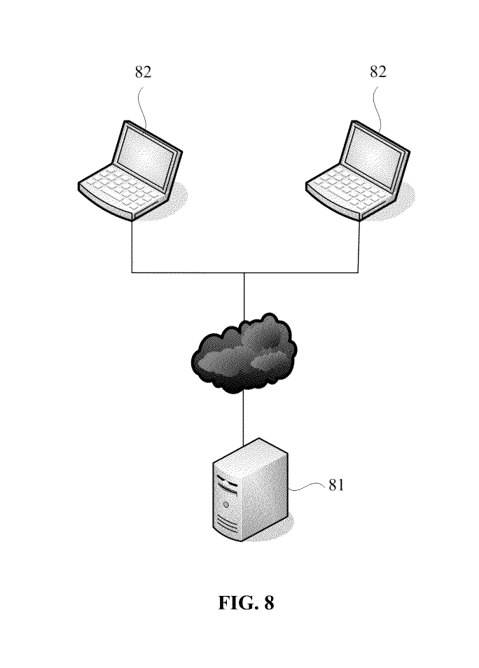

The present disclosure further provides a search term recommendation system. Referring to FIG. 8, FIG. 8 is a structural diagram of a search term recommendation system according to an embodiment of the present invention. The search term recommendation system includes a server 81 and at least one user end 82. The user end 82 is connected to the server 81 by using a network. The user end 82 may be a terminal such as a computer, a mobile phone, or a tablet computer, and the user end 82 is used by a user to input a word or a sentence or sometimes an image that the user intends to search for, and sends the word or sentence or image as an application keyword to the server 81. The server 81 obtains, by using the application keyword sent by the user end 82, a recommended search term that meets a potential search intention of the user, and feeds back the recommended search term to the user end 82, and the user end 82 displays the recommended search term to the user, so that the user can search more clearly. For the function structure of the server 81 in this embodiment, refer to the relevant description about the server in the embodiments in FIG. 6 and FIG. 7. Details are not provided again herein.

In the present disclosure, popular recommended terms with a same functional characteristic can be found by using an application keyword that is input directly by a user or exported from a search result of a general search engine, and are displayed to the user, so that in a case in which a subjective search purpose of the user is unclear, a potential requirement of the user can be excavated, or a requirement of the user can be refined, allowing a search result to better match an intention of the user; therefore, the present disclosure has very strong practicability.

The present disclosure further provides a storage medium (e.g., a non-transitory computer readable storage medium) that includes a computer executable instruction, where when being executed by a processor, the computer executable instruction is used to execute a search term obtaining and/or recommendation method. The method includes: setting a tag library, multiple tags, multiple categories, and multiple application keywords being stored in the tag library; determining whether a received application keyword is a fuzzy keyword; obtaining a tag matching the received application keyword according to the received application keyword if the received application keyword is a fuzzy keyword; obtaining a category corresponding to the matching tag according to the matching tag; gathering the obtained categories, to find a category thereof that appears most frequently; and finding a tag corresponding to the category that appears most frequently as a recommended search term.

The present disclosure further provides another storage medium (e.g., a non-transitory computer readable storage medium) that includes another computer executable instruction, where when being executed by a processor, the computer executable instruction is used to execute a search term recommendation method. The method is used to recommend a search term that meets an intention of a user to a user end by using a server, where a tag library is set on the server, and multiple tags, multiple categories, and multiple application keywords are stored in the tag library. The search term recommendation method includes: sending, by a user end, an application keyword that a user intends to search for to a server; receiving, by the server, the application keyword sent by the user end, and determining whether the received application keyword is a fuzzy keyword; obtaining, by the server, a tag matching the received application keyword according to the received application keyword if the received application keyword is a fuzzy keyword; obtaining, by the server, a category corresponding to the matching tag according to the matching tag; gathering, by the server, the obtained categories, to find a category thereof that appears most frequently; finding, by the server, a tag corresponding to the category that appears most frequently as a recommended search term, and returning the recommended search term to the user end; and displaying, by the user end, the received recommended search term to the user.

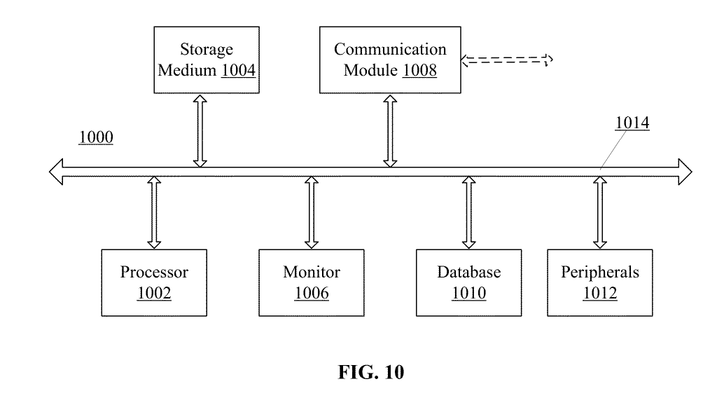

In various embodiments, the server and/or the user end may include, for example, a computer, a mobile phone, or a tablet compute or any suitable computing device, and each may include one or more processors to execute computer executable programs/instructions in parallel. FIG. 10 shows a block diagram of an exemplary computing device used for the disclosed server and/or user end.

As shown in FIG. 10, the computing device may include a processor 1002, storage medium 1004, a monitor 1006, a communication module 1008, a database 1010, peripherals 1012, and one or more bus 1014 to couple the devices together. Certain devices may be omitted and other devices may be included.

Processor 1002 may include any appropriate processor or processors. Further, processor 1002 can include multiple cores for multi-thread or parallel processing. Storage medium 1004 may include memory modules, such as ROM, RAM, and flash memory modules, and mass storages, such as CD-ROM, U-disk, removable hard disk, etc. Storage medium 1004 may store computer programs for implementing various processes, when executed by processor 1002. Storage medium 1004 may be a non-transitory computer readable storage medium.

Further, peripherals 1012 may include I/O devices such as keyboard and mouse, and communication module 1008 may include network devices for establishing connections through a communication network. Database 1010 may include one or more databases for storing certain data and for performing certain operations on the stored data, such as database searching.

In an exemplary operation, the user end may cause the server to perform certain actions, such as an Internet search or other database operations. The server may be configured to provide structures and functions for such actions and operations. More particularly, the server may include a data searching/querying system for real-time database searching. The real-time database searching/querying functionality may be realized by separating a server database into a plurality of databases each having a fixed upper limit on the database capacity, i.e., maximum capacity. Thus, instead of creating indices for a single large database, which may be a large number, indices of the plurality of smaller databases can be created with substantially less amount of time.

The above descriptions are merely preferred embodiments of the present invention, and are not intended to limit the present disclosure in any form. Although the present disclosure has been disclosed above by using the foregoing preferred embodiments, the embodiments are not intended to limit the present disclosure. A person skilled in the art may make replacements or modifications to the above-disclosed technical content without departing from the scope of the technical solutions of the present disclosure to obtain equivalent embodiments. Any alteration, equivalent change or modification made to the above embodiments according to the technical essence of the present disclosure without departing from the content of the technical solutions of the present disclosure shall fall within the scope of the technical solutions of the present disclosure.

What is claimed is:

1. A search term obtaining method, implemented at a server end, comprising:
setting a tag library comprising multiple tags, multiple categories, and multiple application keywords stored there-in;
determining whether a received application keyword is a fuzzy keyword;
obtaining a tag matching the received application keyword according to the received application keyword if the received application keyword is a fuzzy keyword;
obtaining a category corresponding to the matching tag according to the matching tag;
gathering obtained categories to find a category thereof that appears most frequently; and
determining a tag corresponding to the category that appears most frequently as a recommended search term.

2. The search term obtaining method according to claim 1, wherein each of the multiple categories comprises the multiple tags, each of the multiple application keywords corresponds to at least one tag, and each tag belongs to at least one category.

3. The search term obtaining method according to claim 1, wherein the step of determining whether a received application keyword is a fuzzy keyword comprises:
determining whether a correlation score of the received application keyword is lower than a preset correlation score threshold,
determining that the received application keyword is a fuzzy keyword if the correlation score of the received application keyword is lower than the preset correlation score threshold, and
determining that the received application keyword is not a fuzzy keyword if the correlation score of the received application keyword is not lower than the preset correlation score threshold.

4. The search term obtaining method according to claim 1, wherein the received application keyword is input by a user or from a search result output by a search engine.

5. The search term obtaining method according to claim 1, further comprising:
setting a feature library comprising multiple approximate tags stored therein, the approximate tags corresponding to the tags in the tag library,
wherein the step of obtaining a tag matching the received application keyword according to the received application keyword comprises:
obtaining one or more of the tag and an approximate tag matching the received application keyword according to the received application keyword; and
wherein the step of obtaining a category corresponding to the matching tag according to the matching tag comprises:
obtaining a corresponding category according to one or more of the matching tag and the matching approximate tag.

6. The search term obtaining method according to claim 2, wherein the step of determining whether a received application keyword is a fuzzy keyword comprises:
determining whether a correlation score of the received application keyword is lower than a preset correlation score threshold,
determining that the received application keyword is a fuzzy keyword if the correlation score of the received application keyword is lower than the preset correlation score threshold, and
determining that the received application keyword is not a fuzzy keyword if the correlation score of the received application keyword is not lower than the preset correlation score threshold.

7. The search term obtaining method according to claim 2, wherein the received application keyword is input by a user or from a search result output by a search engine.

8. A server, comprising:
a tag library comprising multiple tags, multiple categories, and multiple application keywords stored therein;
a matching unit, configured to determine, after receiving an application keyword, whether the received application keyword is a fuzzy keyword, and to obtain a tag matching the received application keyword according to the received application keyword if the received application keyword is a fuzzy keyword;
a gathering unit, configured to obtain a category corresponding to the matching tag according to the matching tag obtained by the matching unit, and to gather obtained categories to find a category thereof that appears most frequently; and
a recommended term outputting unit, configured to determine a tag corresponding to the category that appears most frequently as a recommended search term.

9. The server according to claim 8, wherein each of the multiple categories comprises the multiple tags, each of the multiple application keywords corresponds to at least one tag, and each tag belongs to at least one category.

10. The server according to claim 8, wherein the matching unit is configured to: determine whether a correlation score of the received application keyword is lower than a preset correlation score threshold, to determine that the received application keyword is a fuzzy keyword if the correlation score of the received application keyword is lower than the preset correlation score threshold, and to determine that the received application keyword is not a fuzzy keyword if the correlation score of the received application keyword is not lower than the preset correlation score threshold.

11. The server according to claim 8, wherein the received application keyword is input by a user or from a search result output by a search engine.

12. The server according to claim 8, further comprising:
a feature library, wherein multiple approximate tags are stored in the feature library, and the approximate tags correspond to the tags in the tag library; and
after receiving the application keyword, the matching unit is configured to obtain one or more of the tag matching the received application keyword from the tag library, and an approximate tag matching the received application keyword from the feature library, and is configured to obtain a corresponding category according to one or more of the matching tag and the matching approximate tag.

13. The server according to claim 9, further comprising:
a feature library, wherein multiple approximate tags are stored in the feature library, and the approximate tags correspond to the tags in the tag library; and
after receiving the application keyword, the matching unit is configured to obtain one or more of the tag matching the received application keyword from the tag library, and an approximate tag matching the received application keyword from the feature library, and is configured to obtain a corresponding category according to one or more of the matching tag and the matching approximate tag.

14. A search term recommendation system, comprising:
a server and at least one user end, the server being configured to receive an application keyword from the user end, and to send a recommended search term to the user end for the user end to display the recommended search term to a user, and the server further comprising:
a tag library comprising multiple tags, multiple categories, and multiple application keywords being stored therein;
a matching unit, configured to receive the application keyword sent by the user end, to determine whether the received application keyword is a fuzzy keyword, and to obtain a tag matching the received application keyword according to the received application keyword if the received application keyword is a fuzzy keyword;
a gathering unit, configured to obtain a category corresponding to the matching tag according to the matching tag obtained by the matching unit, and to gather obtained categories to find a category thereof that appears most frequently; and
a recommended term outputting unit, configured to determine a tag corresponding to the category that appears most frequently as a recommended search term.

15. The search term recommendation system according to claim 14, wherein each of the multiple categories comprises the multiple tags, each of the multiple application keywords corresponds to at least one tag, and each tag belongs to at least one category.

16. The search term recommendation system according to claim 14, wherein the matching unit is configured to: determine whether a correlation score of the received application keyword is lower than a preset correlation score threshold, to determine that the received application keyword is a fuzzy keyword if the correlation score of the received application keyword is lower than the preset correlation score threshold, and to determine that the received application keyword is not a fuzzy keyword if the correlation score of the received application keyword is not lower than the preset correlation score threshold.

17. The search term recommendation system according to claim 14, wherein further comprising:
a feature library, wherein multiple approximate tags are stored in the feature library, and the approximate tags correspond to the tags in the tag library; and
after receiving the application keyword, the matching unit is configured to obtain one or more of the tag matching the received application keyword from the tag library and an approximate tag matching the received application keyword from the feature library, and is configured to obtain a corresponding category according to one or more of the matching tag and the matching approximate tag.

18. The search term recommendation system according to claim 15, wherein the matching unit is configured to: determine whether a correlation score of the received application keyword is lower than a preset correlation score threshold, to determine that the received application keyword is a fuzzy keyword if the correlation score of the received application keyword is lower than the preset correlation score threshold, and to determine that the received application keyword is not a fuzzy keyword if the correlation score of the received application keyword is not lower than the preset correlation score threshold.

19. The search term recommendation system according to claim 15, wherein further comprising:
a feature library, wherein multiple approximate tags are stored in the feature library, and the approximate tags correspond to the tags in the tag library; and
after receiving the application keyword, the matching unit is configured to obtain one or more of the tag matching the received application keyword from the tag library and an approximate tag matching the received application keyword from the feature library, and is configured to obtain a corresponding category according to one or more of the matching tag and the matching approximate tag.
